(19) United States
(12) Patent Application Publication
(10) Pub. No.: US 2014/0232835 A1
(43) Pub. Date: Aug. 21, 2014

(54) STEREOSCOPIC IMAGE PROCESSING DEVICE AND STEREOSCOPIC IMAGE PROCESSING METHOD

(71) Applicant: Asako Kojima, Osaka (JP)

(72) Inventor: Asako Kojima, Osaka (JP)

(21) Appl. No.: 14/238,971

(22) PCT Filed: Mar. 9, 2012
(86) PCT No.: PCT/JP2012/001626

§ 371 Date: Feb. 14, 2014

(30) Foreign Application Priority Data
Aug. 22, 2011 (JP) 2011-180146

(51) Int. Cl. H04N 13/04

(52) U.S. Cl. CPC H04N 13/0402
USPC 348/54

(57) ABSTRACT

A stereoscopic image processing device displays a first image that is a stereoscopic image and a second image that is a stereoscopic image or a two-dimensional image on the same display screen at the same time. The stereoscopic image processing device includes: an acquisition unit that acquires the first image and the second image; and a processing unit that performs image processing on the first image or the second image so that, when a viewer views the first image, the second image appears to be deeper than the first image.

### TECHNICAL FIELD

The present invention relates to stereoscopic image processing devices, and more particularly to a stereoscopic image processing device capable of multi-screen display for displaying a plurality of stereoscopic videos on a display screen at the same time.

### BACKGROUND ART

In recent years, stereoscopic image display devices each displaying a stereoscopic video on a plasma display panel or a liquid crystal panel have actively been developed. For example, stereoscopic image display devices utilizing a disparity between left and right eyes have been known (for example, see Patent Literature 1 (PLT-1)). In the stereoscopic image display device, right-eye images and left-eye images, which have a disparity, are alternately displayed by time sharing on a display panel of the display device. Or, the right-eye images and the left-eye images are displayed alternately for each line on the display panel. A viewer can view the images as a stereoscopic video, by wearing eyeglasses that allows the viewer to view only the right-eye images by a right eye and only the left-eye images by a left eye. A depth and popout of such a stereoscopic video depend on an amount of a disparity between a right-eye image and a left-eye image.

### CITATION LIST

### Patent Literature

[PLT-1] Japanese Unexamined Patent Application Publication No. 2011-35858

### SUMMARY OF INVENTION

### Technical Problem

In the above-described stereoscopic image display device, if a plurality of videos including stereoscopic videos are displayed as multi-screen display on the same screen at the same time, it is common that each of the stereoscopic videos has different depth and popout.

Therefore, there is a problem that a viewer viewing a plurality of stereoscopic videos at the same time feels uncomfortable, and there is a risk that the viewer's health is damaged by, for example, tiredness from viewing the videos.

In order to address the above problem, an object of the present invention is to provide a stereoscopic image processing device that prevents a user from feeling uncomfortable in viewing a plurality of videos which includes at least one stereoscopic video and are displayed as multi-screen display.

### Solution to Problem

In order to solve the above-described problem, in accordance with an aspect of the present invention, there is provided a stereoscopic image processing device which displays a first image and a second image on a same display screen at a same time, the first image being a stereoscopic image, the second image being one of a stereoscopic image and a two-dimensional image, the stereoscopic image processing device comprising: an acquisition unit configured to acquire the first image and the second image; and a processing unit configured to perform image processing on one of the first image and the second image so that, when a viewer views the first image the second image appears to be deeper than the first image.

It should be noted that these general and specific aspects may be implemented as a system, a method, or a computer program, or desired combinations of the system, the method, and the computer program.

### Advantageous Effects of Invention

The stereoscopic image processing device according to the present invention is capable of multi-screen display for a plurality of stereoscopic videos which prevents a viewer from feeling uncomfortable.

### BRIEF DESCRIPTION OF DRAWINGS

FIG. 1 is a diagram showing a configuration of a system according to Embodiment 1.

FIG. 2 is a block diagram of a stereoscopic image processing device according to Embodiment 1.

FIG. 3 is a block diagram showing a detailed structure of a processing unit according to Embodiment 1.

FIG. 4 is a chart for explaining 3D-2D conversion.

FIG. 5A is a diagram showing an example in which a uniform disparity is given to a two-dimensional video so that the video appears to be deeper than a display screen.

FIG. 5B is a diagram showing an example in which a uniform disparity is given to a two-dimensional video so that the video appears to be ahead of a display screen.

FIG. 6A is a diagram showing an example of a screen layout in the case where two videos are displayed without image processing.

FIG. 6B is a top view of an example where two stereoscopic videos are displayed without the image processing.

FIG. 6C is a top view of an example where a stereoscopic video and a two-dimensional video are displayed without the image processing.

FIG. 7 is a flowchart of stereoscopic image processing according to Embodiment 1.

FIG. 8A is a diagram schematically showing an example of stereoscopic image processing in the case where a second video is a stereoscopic video, according to Embodiment 1.

FIG. 8B is a diagram schematically showing an example of stereoscopic image processing in the case where the second video is a two-dimensional video, according to Embodiment 1.

FIG. 9 is a diagram showing how a viewer perceives videos after the stereoscopic image processing according to Embodiment 1.

FIG. 10A is a diagram schematically showing an example of stereoscopic image processing in the case where a second video is a stereoscopic video, according to Embodiment 2.

FIG. 10B is a diagram schematically showing an example of stereoscopic image processing in the case where the second video is a two-dimensional video, according to Embodiment 2.

FIG. 11 is a diagram showing how a viewer perceives videos after the stereoscopic image processing according to Embodiment 2.

FIG. 12 is a flowchart of stereoscopic image processing according to Embodiment 3.

FIG. 13 is a diagram showing how a viewer perceives videos after the stereoscopic image processing according to Embodiment 3.

FIG. 14 is a diagram showing an example of stereoscopic image processing according to one embodiment of the present invention.

FIG. 15 is a diagram showing an application example of the stereoscopic image processing device according to one embodiment of the present invention.

### DESCRIPTION OF EMBODIMENTS

In accordance with an aspect of the present invention, there is provided a stereoscopic image processing device which displays a first image and a second image on a same display screen at a same time, the first image being a stereoscopic image, the second image being one of a stereoscopic image and a two-dimensional image, the stereoscopic image processing device comprising: an acquisition unit configured to acquire the first image and the second image; and a processing unit configured to perform image processing on one of the first image and the second image so that, when a viewer views the first image, the second image appears to be deeper than the first image.

Thereby, when the viewer intends to focus on a certain image (first image) in viewing a plurality of images at the same time, it is possible to display the other image (second image) not to prevent the viewer from viewing the certain image.

For example, it is also possible that the processing unit is configured to process one of the first image and the second image so that the second image appears to be a two-dimensional image displayed deeper than the first image.

For example, it is further possible that the processing unit is configured to, in a case where a plane which passes through a position appearing farthest from the viewer in the first image when the viewer views the first image and is parallel to the display screen is a first plane, perform the image processing on one of the first image and the second image, so that the viewer perceives the second image as a two-dimensional image displayed on the first plane or that the viewer perceives the second image as a two-dimensional image displayed farther than the first plane.

It is still further possible that the processing unit is configured to convert the second image to a stereoscopic image having a uniform disparity, so that the viewer perceives the second image as a two-dimensional image displayed on a same plane as the first plane or that the viewer perceives the second image as a two-dimensional image displayed farther than the first plane.

It is still further possible that the second image is a stereoscopic image, and the processing unit is configured to: select, as a selected image, one of a left-eye image and a right-eye image which are included in the second image; generate a third image by translating the selected image in a horizontal direction of the display screen; and convert the second image to a stereoscopic image in which one of the selected image and the third image is a left-eye image and an other one of the selected image and the third image is a right-eye image.

It is still further possible that the second image is a two-dimensional image, and the processing unit is configured to:

generate a fourth image by translating the second image in a horizontal direction of the display screen; and convert the second image to a stereoscopic image in which one of the second image and the fourth image is a left-eye image and an other one of the second image and the fourth image is a right-eye image.

It is still further possible that the processing unit is configured to display the second image as a two-dimensional image on the display screen, and process the first image to have a uniform disparity so that the viewer perceives the first plane as a same plane as a plane of the display screen or as a plane closer to the viewer than the display screen is.

It is still further possible that the second image is a stereoscopic image, and the processing unit is configured to display, on the display screen, only one of a left-eye image and a right-eye image which are included in the second image, and convert only one of a left-eye image and a right-eye image which are included in the first image into an image by translating the one of the left-eye image and the right-eye image in a horizontal direction of the display screen.

It is still further possible that the second image is a two-dimensional image, and the processing unit is configured to convert one of a left-eye image and a right-eye image which are included in the first image into an image by translating the one of the left-eye image and the right-eye image in a horizontal direction of the display screen.

It is still further possible that the stereoscopic image processing device further comprises a scaler that changes a size of the first image and a size of the second image on the display screen.

It is still further possible that the stereoscopic image processing device further comprises an input receiving unit configured to receive an input of the viewer to select, from among images displayed on the display screen, an image which the viewer intends to focus on, wherein the first image is an image selected by the viewer.

It is still further possible that the first plane is a plane appearing in parallel to the display screen.

In accordance with another aspect of the present invention, there is provided a stereoscopic image processing method of displaying a first image and a second image on a same display screen at a same time, the first image being a stereoscopic image and the second image being one of a stereoscopic image and a two-dimensional image, the stereoscopic image processing method comprising: acquiring the first image and the second image; and performing image processing on one of the first image and the second image so that, when a viewer views the first image, the second image appears to be deeper than the first image.

In other words, the present invention can be implemented as a stereoscopic image processing method.

Hereinafter, embodiments of the present inventions are described in greater detail with reference to the accompanying Drawings.

It should be noted that all the embodiments described below are specific examples of the present invention. Numerical values, shapes, materials, constituent elements, arrangement positions and the connection configuration of the constituent elements, steps, the order of the steps, and the like described in the following embodiments are merely examples, and are not intended to limit the present invention. Therefore, among the constituent elements in the following embodiments, constituent elements that are not described in independent claims that show the most generic concept of the present invention are described as elements constituting more desirable configurations.

The present invention is a stereoscopic image processing device that performs multi-screen display for displaying a plurality of stereoscopic videos on the same screen at the same time. When a viewer intends to focus on a certain video in viewing the plurality of videos, the stereoscopic image processing device displays the videos not to prevent the viewer from viewing the certain video.

Patent Literature 1 discloses an image processing device that adjusts a depth of a subtitled video, which has been synthesized as a stereoscopic video and displayed, by scaling processing for changing a size of the stereoscopic video on a display screen. Therefore, even if the scaling processing changes the disparity of the stereoscopic video, it is possible to adjust the video to display subtitles appearing closer to the viewer than any videos.

In the image processing device disclosed in Patent Literature 1, the depth (disparity) of the subtitles is independently set in the image processing device. In other words, the disparity of the subtitles can be freely set without consideration of the stereoscopic video displayed together with the subtitles.

In contrast, the present invention differs from the technique disclosed in Patent Literature 1 in that a disparity is adjustable in keeping features of a plurality of stereoscopic videos each having a different disparity.

### Embodiment 1

(Device Structure)

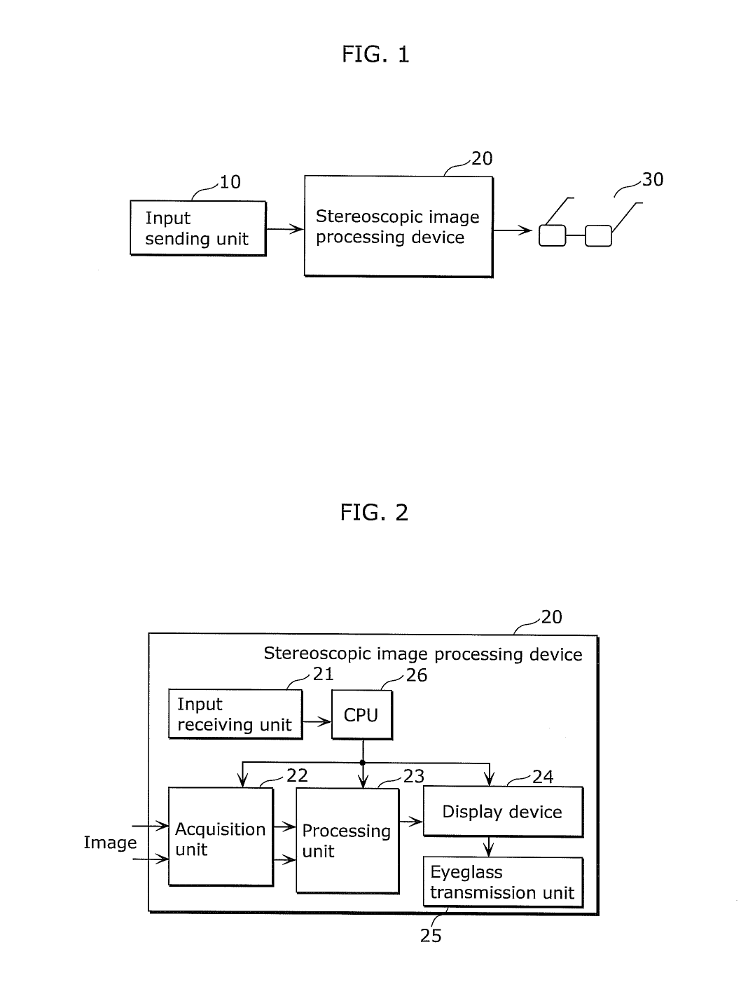

FIG. 1 is a diagram showing a configuration of a stereoscopic image display system according to Embodiment 1.

The following describes the configuration of the system including an image processing device according to the present embodiment with reference to FIG. 1.

The stereoscopic image display system includes an input sending unit 10, a stereoscopic image processing device 20, and stereoscopic image viewing eyeglasses 30.

The input sending unit 10 receives an input from a viewer, and sends an operation signal according to the input to the stereoscopic image processing device 20. The input sending unit 10 is, for example, a remote controller which allows the viewer to operate the stereoscopic image processing device 20. The input sending unit 10 and the stereoscopic image processing device 20 are connected to each other by infrared ray or radio.

The stereoscopic image processing device 20 acquires videos from broadcast waves, network, or storage mediums, and displays the videos as stereoscopic videos. In other words, the stereoscopic image processing device 20 can be applied to a television receiving device, a liquid crystal display device, or a plasma display device. The stereoscopic image processing device 20 according to the present invention can display a plurality of videos on the same display device (display screen) at the same time.

The stereoscopic image processing device 20 converts videos to be displayed on the display device, according to the operation signal sent from the input sending unit 10.

Furthermore, the stereoscopic image processing device 20 alternately displays right-eye images and left-eye images when displaying a stereoscopic video on the display device. In addition, the stereoscopic image processing device 20 transmits LR signals to the stereoscopic image viewing eyeglasses 30 in synchronization with times of displaying right-eye images and left-eye images on the display device. The LR signal indicates which is currently displayed between a right-eye image or a left-eye image. The LR signal is a digital signal indicating, for example, a high level (1) when a right-eye image is displayed, and a low level (0) when a left-eye image is displayed.

The stereoscopic image viewing eyeglasses 30 are eyeglasses used by the viewer viewing a stereoscopic video displayed by the stereoscopic image processing device 20. The stereoscopic image viewing eyeglasses 30 includes a liquid crystal shutter provided to a lens part of the eyeglasses, and controls the liquid crystal shutter to be opened and closed according to the LR signals received from the stereoscopic image processing device 20. The stereoscopic image viewing eyeglasses 30 allow the viewer to view only right-eye images by a right eye, and only left-eye images by a left eye. The stereoscopic image viewing eyeglasses 30 control the liquid crystal shutter based on LR signals received from the stereoscopic image processing device 20. The stereoscopic image processing device 20 and the stereoscopic image viewing eyeglasses 30 are connected to each other by infrared ray or radio.

It is also possible that the stereoscopic image processing device 20 does not include the stereoscopic image viewing eyeglasses 30. For example, the stereoscopic image processing device 20 may be applied to display devices not using the stereoscopic image viewing eyeglasses 30, such as a display device provided with a lenticular lens on its display screen.

Next, the structure of the stereoscopic image processing device 20 is described in more detail.

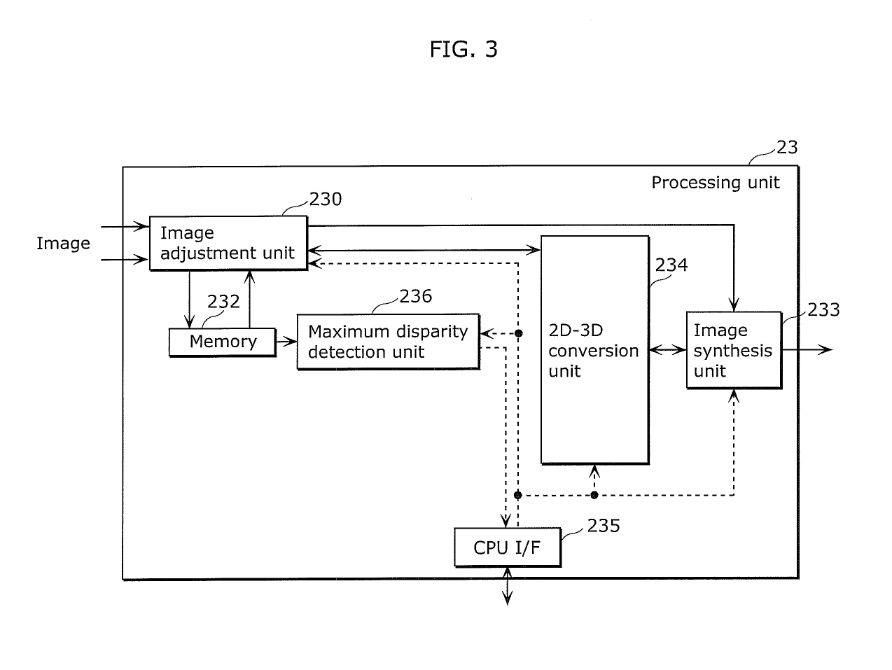

FIG. 2 is a block diagram of the stereoscopic image processing device according to Embodiment 1.

The stereoscopic image processing device 20 includes an input receiving unit 21, an acquisition unit 22, a processing unit 23, a display device 24, and an eyeglass transmission unit 25.

The input receiving unit 21 is a receiving device that receives infrared ray or radio. When the input receiving unit 21 receives an operation signal from the input sending unit 10, the input receiving unit 21 transmits the operation signal to a Central Processing Unit (CPU) 26.

The acquisition unit 22 acquires videos according to the control signals provided from the CPU 26. More specifically, the acquisition unit 22 includes software, a dedicated hardware, and the like.

The acquisition unit 22 acquires a plurality of videos (image signals) from an external device via broadcast waves, a network, a storage medium, a cable such as High-Definition Multimedia Interface (HDMI), or the like. The video which the acquisition unit 22 acquires may be a stereoscopic video or a two-dimensional video. It should be noted that the videos which the acquisition unit 22 acquires may include compressed videos.

Furthermore, the acquisition unit 22 converts an acquired video to a video corresponding to a processing format of the processing unit 23. The image conversion is, for example, decoding of a compressed image, or conversion from an analog image to a digital image. Moreover, the above-described image conversion includes processing for converting, for each vertical synchronization signal, an image consisting of a right-eye image and a left-eye image, into an image corresponding to the right-eye image and an image corresponding to the left-eye image for two respective vertical synchronization signals. The images which the acquisition unit 22 transmits to the processing unit 23 include not only so-called image signals (YUV/RGB) but also vertical synchronization signals, horizontal synchronization signals, and the like.

It should be noted that it will be described in the present embodiment described below that the acquisition unit 22 acquires two videos, but the number of the videos acquired by the acquisition unit 22 is not limited as long as the acquisition unit 22 acquires a plurality of videos.

The processing unit 23 performs scaling processing on each of the videos provided from the acquisition unit 22, in order to adjust a position of a target video on the display screen of the display device 24, and increase or decrease a size of the target video. The processing unit 23 also performs processing for synthesizing two videos provided from the acquisition unit 22, and processing for converting a two-dimensional video provided from the acquisition unit 22 into a stereoscopic video.

The processing unit 23 provides the processed image signals to the display device 24. In addition, the processing unit 23 generates the above-described LR signals, and provides the LR signals to the display device 24. Functions and a structure of the processing unit 23 will be described in more detail later.

The display device 24 displays the video provided from the processing unit 23, on the display screen of the display device 24. The display device 24 transmits the LR signals provided from the processing unit 23, to the eyeglass transmission unit 25.

It should be noted that it has been described in the present embodiment that the stereoscopic image processing device 20 includes the display device 24, but the display device 24 is not necessarily included in the stereoscopic image processing device 20. For example, the stereoscopic image processing device 20 may output videos to another display device. In other words, the stereoscopic image processing device 20 may be applied to a Blu-Ray recorder or the like.

The eyeglass transmission unit 25 transmits the LR signals, which have been provided from the display device 24, to the stereoscopic image viewing eyeglasses 30 by infrared ray or radio.

The CPU 26 controls the acquisition unit 22, the processing unit 23, and the display device 24 based on operation signals provided from the input receiving unit 21.

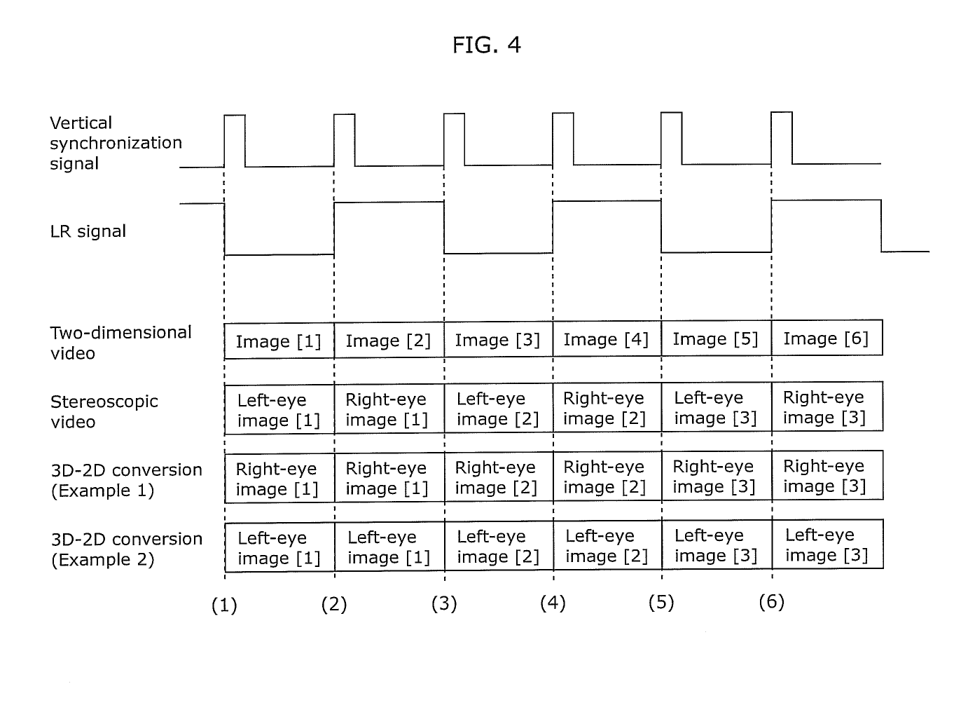

Next, the structure of the processing unit 23 is described in more detail with reference to FIG. 3.

FIG. 3 is a block diagram showing a detailed structure of the processing unit 23.

The processing unit 23 includes an image adjustment unit 230, a memory 232, an image synthesis unit 233, a two-dimensional three-dimensional (2D-3D) conversion unit 234, a Central Processing Unit/Interface (CPU I/F) 235, and a maximum disparity detection unit 236.

The image adjustment unit 230 performs processing on a video provided from the acquisition unit 22, based on the control signal provided from the CPU I/F 235. The details (functions) of the image processing will be described later.

A video processed by the image adjustment unit 230 is written into the memory 232, and then read from the memory 232 and provided to the image synthesis unit 233 or the 2D-3D conversion unit 234. The video generated by the image adjustment unit 230 means signals including vertical synchronization signals, horizontal synchronization signals, image signals (YUV/RGB), and LR signals. The LR signals are generated by the image adjustment unit 230. It should be noted that the vertical synchronization signals, the horizontal synchronization signals, and the LR signals, all of which are provided from the image adjustment unit 230, are in synchronization with each other.

The detailed functions of the image adjustment unit 230 are described below. It should be noted that the image adjustment unit 230 may be implemented as software, a hard ware, or a functional element in LSI.

[Image Size Increase/Decrease Scaling Function]

The image adjustment unit 230 functions as a scaler for changing (scaling) a size of an image (video) displayed on the display screen of the display device 24. Although it is described in the present embodiment that the scaling processing is performed before a target image is written to the memory 232, but the scaling processing may be performed after a target image is read from the memory 232.

[Image Position Adjustment Function]

The image adjustment unit 230 is capable of changing (adjusting) a position of a video on the display screen of the display device 24. In Embodiment 1, the image position adjustment is performed when reading the image from the memory 232.

[3D-2D Conversion Function for Stereoscopic Image Signals]

The image adjustment unit 230 functions as a 3D-2D conversion unit that reads, from among right-eye images and left-eye images in a stereoscopic video written to the memory 232, only the right-eye images or only the left-eye images in synchronization with vertical synchronization signals, and outputs the stereoscopic video as a two-dimensional video.

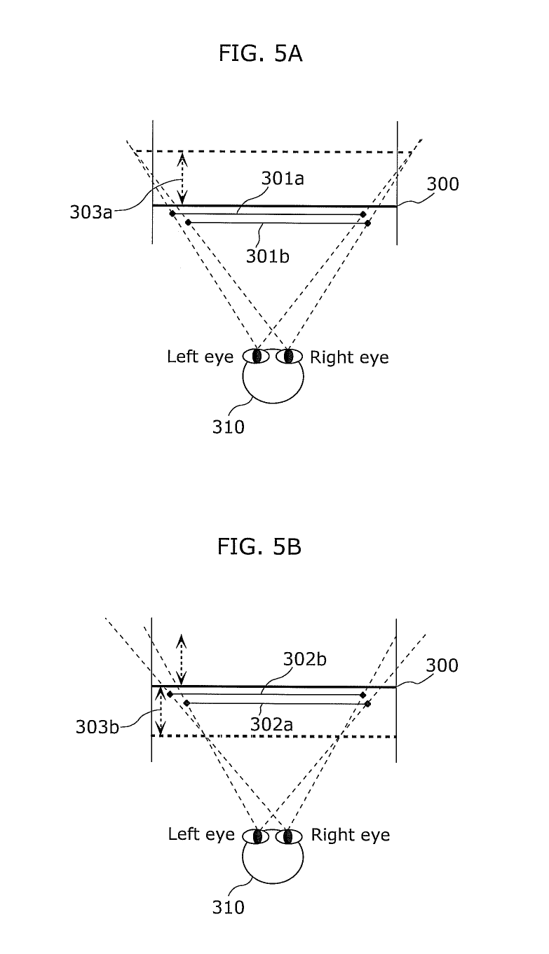

FIG. 4 is a diagram for explaining the 3D-2D conversion.

For example, when vertical synchronization signals (frame rate) are at 60 Hz, if a target video is a two-dimensional video, 60 frames per one second are outputted from the two-dimensional video. In other words, as shown in FIG. 4, images [1] to [6] which are included in a two-dimensional video are continuously outputted in synchronization with respective rising times of vertical synchronization signals.

In contrast, in the case of a stereoscopic video, an image included in right-eye images and an image included in left-eye images are alternately outputted per second, depending on whether the LR signal is High or Low. Therefore, when the vertical synchronization signals are at 60 Hz, 30 right-eye images in a right-eye video and 30 left-eye images in a left-eye video are outputted per second. In other words, as shown in FIG. 4, in synchronization with respective rising times of the vertical synchronization signals, right-eye images and left-eye images are alternately and continuously outputted in order of, for example, the left-eye image [1], the right-eye image [1], the left-eye image [2], the right-eye image [2], the left-eye image [3], the right-eye image [3], . . . .

In the 3D-2D conversion processing performed by the image adjustment unit 230, for example, only right-eye images are outputted by outputting each of the right-eye images twice in a row. As a result, a stereoscopic video is outputted as a two-dimensional video. As shown in (Example 1) in FIG. 4, only right-eye images are outputted. Each of the right-eye images is outputted twice in a row in synchronization with vertical synchronization signals. For example, the right-eye image [1], the right-eye image [1], the right-eye image [2], the right-eye image [2], the right-eye image [3], the right-eye image [3], . . . are sequentially outputted in that order. In short, the image adjustment unit 230 reads only right-eye images from the memory 232 and outputs them.

Likewise, as shown in (Example 2) in FIG. 4, only left-eye images may be outputted. Each of the left-eye images may be outputted twice in a row in synchronization with vertical synchronization signals. For example, the left-eye image [1], the left-eye image [1], the left-eye image [2], the left-eye image [2], the left-eye image [3], the left-eye image [3], . . . are sequentially outputted in that order. In short, the image adjustment unit 230 may read only left-eye images from the memory 232 and output them.

[Image Signal Output Time Adjustment Function]

The image adjustment unit 230 reads a video from the memory 232 and outputs the video, according to the same vertical synchronization signals, the same horizontal synchronization signals, and the same LR signals.

Therefore, a video outputted from the image adjustment unit 230 is synchronized.

Next, the maximum disparity detection unit 236 is described.

Based on control signals provided from the CPU I/F 235, the maximum disparity detection unit 236 detects a disparity from a stereoscopic video written in the memory 232.

Hereinafter, as an example, it is assumed that, when the image adjustment unit 230 writes a stereoscopic video into the memory 232, left-eye images and right-eye images included in the stereoscopic video are alternately written, in order of a left-eye image, a right-eye image, a left-eye image, a right-eye image, . . . .

Likewise, it is assumed that, when the image adjustment unit 230 reads a stereoscopic video from the memory 232, left-eye images and right-eye images included in the stereoscopic video are alternately read out, in order of a left-eye image, a right-eye image, a left-eye image, a right-eye image, . . . .

When the image adjustment unit 230 writes, for each line (scan line), right-eye images included in a stereoscopic video into the memory 232, the maximum disparity detection unit 236 detects a disparity between a left-eye image and a right-eye image for each line, by matching (a) one horizontal line of right-eye images and (b) one horizontal line of left-eye images which have already been written in the memory.

In the matching, for example, a block having a predetermined range is determined from a left-eye image, and horizontal coordinates (pixel position) of the block in the left-eye image is compared to horizontal coordinates of a co-located block in a corresponding right-eye image.

When a maximum disparity is to be detected from a single frame (a pair of a left-eye image and a right-eye image), the maximum disparity detection unit 236 detects a disparity for each of lines in the single frame, and determines the largest disparity in the frame as a maximum disparity.

Furthermore, when a maximum disparity in a stereoscopic video in a predetermined period is to be detected, the maximum disparity detection unit 236 detects the above-described disparity for each frame (each pair of a left-eye image and a right-eye image) included in the predetermined period, and determines, as a maximum disparity, the largest disparity in the predetermined period.

It should be noted that the maximum disparity detection unit 236 detects both (a) a maximum disparity in a direction towards the viewer from the display screen as viewed from the viewer (popout amount) and (b) a maximum disparity in a direction away from the display screen as viewed from the viewer (depth amount). Here, the popout amount is a maximum disparity in the case where a subject in a right-eye image appears to the right of the same subject in a corresponding left-eye image. The depth amount is a maximum disparity in the case where a subject in a right-eye image appears to the left of the same subject in a corresponding left-eye image.

The maximum disparity detection unit 236 transmits information indicating the detected maximum disparity to the CPU I/F 235 when writing of the right-eye images in the stereoscopic video into the memory 232 is completed.

Next, the 2D-3D conversion unit 234 is described.

In Embodiment 1, the 2D-3D conversion unit 234 converts a two-dimensional video provided from the image adjustment unit 230 into a stereoscopic video that includes right-eye images and left-eye images having a uniform disparity. (In Embodiment 2 described later, a stereoscopic video generated by the image adjustment unit 230 is further processed to have a uniform disparity. In Embodiment 3 described later, a two-dimensional video synthesized by the image synthesis unit 233 is converted to a stereoscopic video having a desired disparity.)

The expression “have a uniform disparity” means that a distance between each pair of co-located pixels in a right-eye image and a left-eye image in a stereoscopic video is uniform in a horizontal direction of the video. In other words, a position of each pixel in a right-eye image and a position of a co-located pixel in a left-eye image on the display screen are uniformly offset in the horizontal direction of the display screen.

A stereoscopic video having a uniform disparity can be generated by translating images, which are included in a two-dimensional video provided from the image adjustment unit 230, in the horizontal direction of the display screen and outputting the translated images.

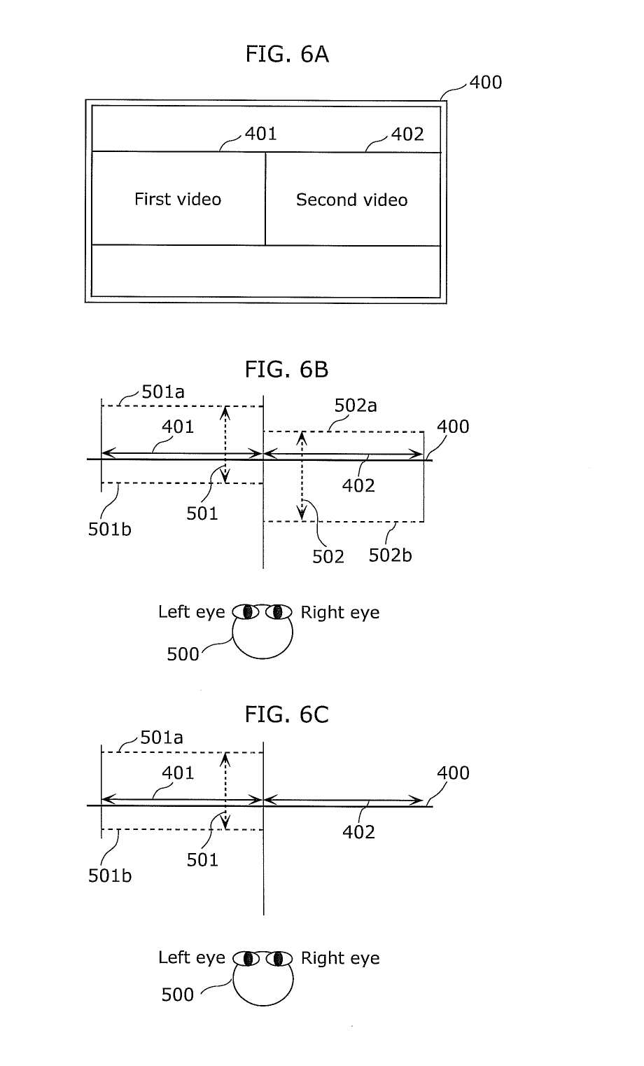

FIG. 5A is a diagram showing an example in which a two-dimensional video is processed to have a uniform disparity and then displayed to appear deeper than the display screen.

For example, at a time when the above-described LR signal is 0 (a time for outputting a left-eye image), an image 301a that is generated by translating an image to be outputted at the time to the left is outputted. On the other hand, at a time when the LR signal is 1 (a time for outputting a right-eye image), an image 301b that is generated by translating an image to be outputted at the time to the right is outputted. As a result, two-dimensional video is processed to have a uniform disparity, so that the viewer 310 perceives the two-dimensional video appearing on a plane deeper than the display screen 300 with a distance 303a.

FIG. 5B is a diagram showing an example in which a two-dimensional video is processed to have a uniform disparity and appear ahead of the display screen.

At a time when the LR signal is 0, an image 302a that is generated by translating an image to be outputted at the time to the right is outputted. On the other hand, at a time when the LR signal is 1, an image 302b that is generated by translating an image to be outputted at the time to the left is outputted. As a result, the two-dimensional video is processed to have a uniform disparity, so that the viewer 310 perceives the two-dimensional video appearing on a plane ahead of the display screen 300 with a distance 303b.

It should be noted that when an image generated by translating an image included in a two-dimensional video read from the memory 232 is converted to a pair of a left-eye image and a right-eye having a uniform disparity in the above manner, end portions of the left-eye image and the right-eye image are lost by a shift amount of the translation. Therefore, it is also possible that a size of each of two-dimensional images read from the memory 232 is decreased in consideration of a shift amount, and then each two-dimensional image is translated to generate a target image.

It should be note that, when a stereoscopic video having a uniform disparity is to be generated, it is also possible to translate only images outputted at times when the LR signal is 0, or of course, translate only images outputted at times when the LR signal is 1.

It should also be noted that the 2D-3D conversion unit 234 may process a two-dimensional video to have a disparity on a pixel-by-pixel basis, so as to convert the two-dimensional video to a stereoscopic video having various disparities on the screen. In short, the 2D-3D conversion unit 234 can generate a stereoscopic video having a disparity/disparities as desired.

The above conversion processing can be achieved by an algorithm such as a pseudo 3D function used in display devices capable of stereoscopic display.

Furthermore, for example, the above algorithm includes a function of correcting a disparity to have a maximum or minimum value within a predetermined disparity range for a pixel having a disparity exceeding the predetermined disparity range.

Such conversion processing performed by the 2D-3D conversion unit 234 is used to convert a two-dimensional video acquired by the acquisition unit 22 to a stereoscopic video. In the present embodiment, the conversion processing is used to convert a two-dimensional video synthesized by the image synthesis unit 233 to a stereoscopic video having a desired disparity in Embodiment 3 as described later.

It should be noted that, hereinafter, a uniform disparity or a disparity is described also as a position at which a video appears. For example, in FIG. 5A, the distance 303a is sometimes described as a uniform disparity. In such a case, to be precise, an image is processed to have a (uniform) disparity so as to appear at the position having the distance 303a.

Next, the image synthesis unit 233 is described.

The image synthesis unit 233 synthesizes videos provided from the image adjustment unit 230 or the 2D-3D conversion unit 234 under control of the CPU I/F 235, and outputs the resulting video. The videos provided from the image adjustment unit 230 or the 2D-3D conversion unit 234 are in synchronization with each other. More specifically, in the same manner as described in the example with reference to FIG. 4, in synchronization with the same vertical synchronization signal, the image synthesis unit 233 receives (a) an image included in a video outputted from the image adjustment unit 230 and (b) an image included in a video outputted from the 2D-3D conversion unit 234.

The image synthesis unit 233 synthesizes (a) the image included in the video outputted from the image adjustment unit 230 and (b) the image included in the video outputted from the 2D-3D conversion unit 234 so as to generate a synthesized image. Then, the image synthesis unit 233 outputs such synthesized images as a synthesized video to the display device 24 in synchronization with the vertical synchronization signal.

The CPU I/F 235 is an interface for mediating between the CPU 26 and each block in the processing unit 23. The CPU I/F 235 transmits control signals provided from the CPU 26, to the image adjustment unit 230, the image synthesis unit 233, the 2D-3D conversion unit 234, and the maximum disparity detection unit 236.

The memory 232 is a storage unit in which videos (videos) are temporarily stored. The detailed structure of the memory 232 is not specifically limited, and the memory 232 may be any means capable of storing data. For example, the memory 232 may be a Dynamic Random Access Memory (DRAM), a Synchronous Dynamic Random Access Memory (SDRAM), a flash memory, a ferroelectric memory, a Hard Disk Drive (HDD), or the like.

(Processing 1 of Stereoscopic Image Processing Device)

The following describes processing performed by the stereoscopic image processing device according to Embodiment 1.

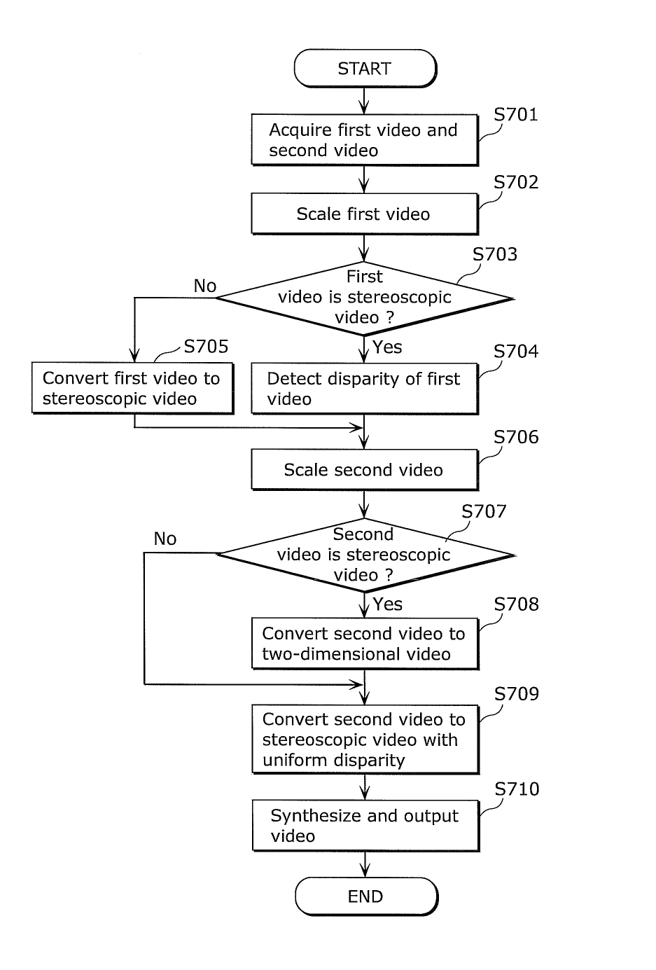

FIG. 6A is a diagram showing an example of a screen layout in the case where acquired two videos are displayed on the display screen of the display device 24 without the image processing. FIG. 6A is a front view of the display screen.

FIG. 6B is a top view showing an example in the case where the two stereoscopic videos are displayed without the image processing.

As shown in FIG. 6A, the display device 24 displays a first video (referred to also as a first image) 401 and a second video (referred to also as a second image) 402 on a display screen 400 at the same time. The first video 401 and the second video 402 are acquired by the image adjustment unit 230. The displayed first video 401 and the displayed second video 402 have decreased sizes.

Therefore, when the first video 401 and the second video 402 are displayed on the display screen 400 without the image processing, the first video 401 and the second video 402 have respective different maximum disparity ranges.

The maximum disparity range refers to a distance between a first plane 501a and a second plane 501b. The first plane 501a is parallel to the display screen 400 and passes through a position perceived as the farthest from a viewer 500 in the video as viewed from the viewer 500. The second plane 501b is parallel to the display screen 400 and passes through a position perceived as the closest to the viewer 500 in the video as viewed from the viewer 500.

Here, the “farthest” and the “closest” mean a position relationship between a target plane and the viewer 500 facing the display screen in a direction perpendicular to the display screen 400. (Unless otherwise noted, the same goes for the following description.)

For example, when both the first video 401 and the second video 402 are stereoscopic videos as shown in FIG. 6B, a distance between the first plane 501a and the second plane 501b of the first video 401 is a maximum disparity range 501 of the first video 401.

Likewise, a distance between a first plane 502a and a second plane 502b of the second video 402 is a maximum disparity range 502 of the second video 402.

It should be noted that a distance from the display screen 400 to the first plane 501a is a maximum disparity in a direction (depth direction) away from the display screen 400 when viewed from the viewer 500. A distance from the display screen 400 to the second plane 501b is a maximum disparity in a direction (popout direction) towards the viewer 500 from the display screen 400 when viewed from the viewer 500.

Therefore, in other words, a maximum disparity range is a sum of a maximum disparity in a depth direction and a maximum disparity in a popout direction.

In FIG. 6B, regarding the first video 401, the maximum disparity in the depth direction is greater than the maximum disparity in the popout direction. On the other hand, regarding the second video 402, the disparity in the popout direction is greater than the disparity in the depth direction.

As described above, when videos having respective different maximum disparity ranges are displayed on the display screen 400 at the same time, the viewer 500 views the videos having the different maximum disparity ranges in parallel. When viewing the videos having the different disparity ranges in parallel, the viewer 500 feels uncomfortable and there is a risk that the health of the viewer 500 is damaged by, for example, tiredness from the viewing.

Although in FIG. 6B, the two videos are stereoscopic videos, the same goes for the case where one of the videos is a two-dimensional video.

FIG. 6C is a top view showing an example in which an acquired stereoscopic video and an acquired two-dimensional video are displayed on the display screen 400 of the display device 24 without the image processing.

Like FIG. 6B, in FIG. 6C, the first video 401 is a stereoscopic video having the maximum disparity range 501. On the other hand, a second video 402 is a two-dimensional video which does not have a disparity range and therefore appears on the display screen 400.

As described above, if the viewer 500 is viewing a stereoscopic video and a two-dimensional video at the same time and the two-dimensional video appears within a disparity range of the stereoscopic video, the viewer 500 feels uncomfortable and there is a risk of putting the load on the viewer 500 during the viewing.

Therefore, in the present invention, processing is performed to display one of videos (the second video 402) not to prevent the viewer from viewing the other video (the first video 401).

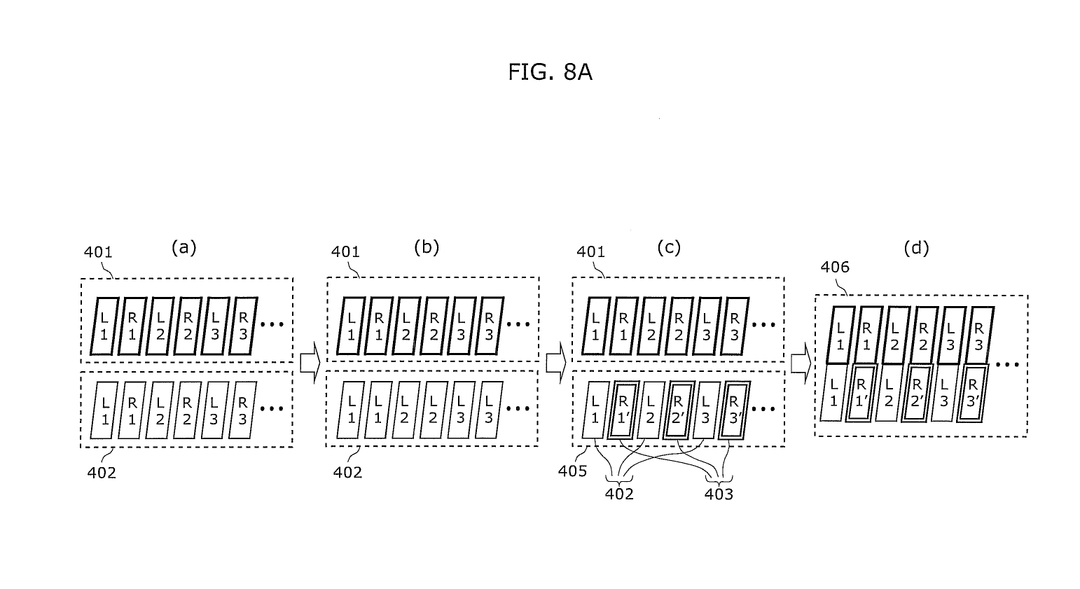

FIG. 7 is a flowchart of the stereoscopic image processing according to Embodiment 1.

First, the acquisition unit 22 acquires a first video and a second video (S701).

Next, the image adjustment unit 230 scales the first video 401 (S702). More specifically, the image adjustment unit 230 determines a region in which the first video 401 is to be displayed on the display screen 400 as shown in FIG. 6A.

If the first video 401 is a stereoscopic video (Yes at S703), the maximum disparity detection unit 236 detects a disparity of the scaled first video 401 (S704). In other words, the maximum disparity detection unit 236 detects a distance from the display screen 400 to the first plane 501a. The scaled first video 401 is stored to the memory 232 without the image processing.

Here, the maximum disparity detection unit 236 may detect a maximum disparity range 501.

On the other hand, if the first video 401 is not a stereoscopic video (No at S703), the 2D-3D conversion unit 234 converts the first video 401 to a stereoscopic video (S705). In this case, the first video 401 is converted to a stereoscopic video to have a predetermined disparity, so that the disparity detection processing (S704) is not necessarily performed. For the 2D-3D conversion, an existing pseudo 3D algorithm or the like is applied. In this case, the first video 401 which has been scaled and converted to the stereoscopic video is stored in the memory 232.

Next, the image adjustment unit 230 scales the second video 402 (S706). More specifically, the image adjustment unit 230 determines a region in which the second video 402 is displayed on the display screen 400 as shown in FIG. 6A.

Here, if the second video 402 is a stereoscopic video (Yes at S707), the image adjustment unit 230 performs 3D-2D conversion on the second video 402 (S708). More specifically, as described with reference to FIG. 4, the image adjustment unit 230 reads either right-eye images or left-eye images from the second video 402 and outputs the readout images.

If the second video 402 is a two-dimensional video (No at S707), the image adjustment unit 230 reads the second video 402 as a two-dimensional video without performing the image processing (the 3D-2D conversion) and outputs the readout video to the 2D-3D conversion unit 234 (S708). More specifically, as described with the reference to FIG. 4, the image adjustment unit 230 reads either right-eye images or left-eye images from the second video 402 and outputs the readout images.

Subsequently, the 2D-3D conversion unit 234 converts the second video 402 provided as the two-dimensional video from the image adjustment unit 230, into a stereoscopic video having a uniform disparity (S709).

Here, if the first video 401 acquired by the acquisition unit 22 is a stereoscopic video, the uniform disparity of the second video 402 is equal to or more than the disparity of the first video 401 (a distance from the display screen 400 to the first plane 501a) which has been detected by the maximum disparity detection unit 236 at Step S704. On the other hand, if the first video 401 acquired by the acquisition unit 22 is a two-dimensional video, the uniform disparity of the second video 402 is equal to or more than the disparity in the depth direction of the converted first video 401 which has been converted to the stereoscopic video at Step S705 (a distance from the display screen 400 to the first plane 501a of the converted first video 401).

As a result, the converted second video 402 appears farther than the first plane 501a of the first video 401.

It should be noted that a maximum disparity range of each video is not always constant while the video is being displayed on the display screen 400. Therefore, the maximum disparity detection unit 236 regularly detects a disparity.

The first video 401 which is outputted from the image adjustment unit 230 and the stereoscopic video with the uniform disparity which is outputted from the 2D-3D conversion unit 234 are outputted to the image synthesis unit 233 in synchronization with each other. The image synthesis unit 233 outputs a single stereoscopic video which is generated by synthesizing (a) the first video 401 and (b) the stereoscopic video with the uniform disparity, to the display device 24 (S710).

Next, with reference to Steps S707 to S710 in FIG. 7, the description is given in detail for the case where the second video 402 is a stereoscopic video and for the case where the second video 402 is a two-dimensional video.

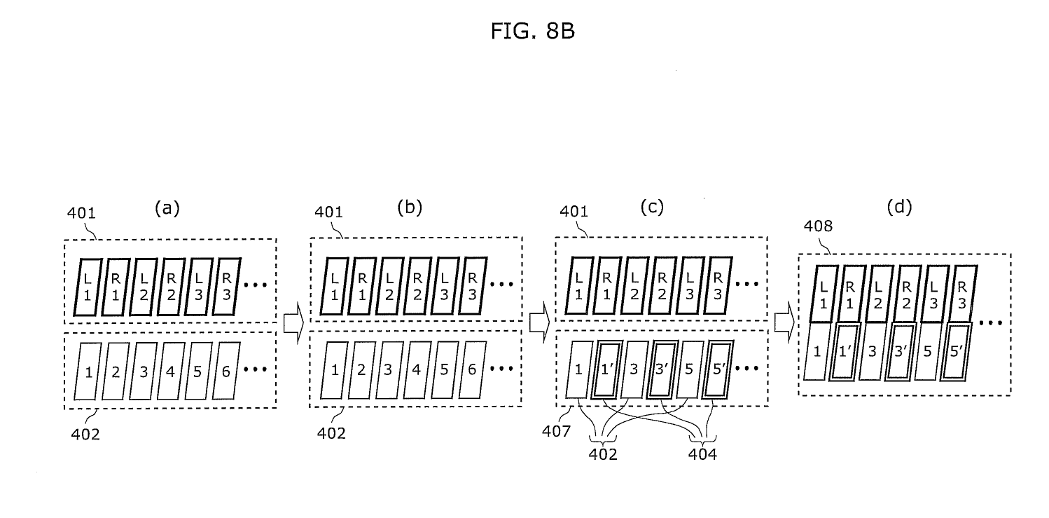

FIG. 8A is a diagram schematically showing an example of the stereoscopic image processing according to Embodiment 1 in the case where the second video 402 is a stereoscopic video (Yes at S707 in FIG. 7).

(a) in FIG. 8A shows, at Step S707 in FIG. 7, the first video 401 and the second video 402 which are stored in the memory 232. More specifically, the memory 232 holds: left-eye images and right-eye images included in the first video 401; and left-eye images and right-eye images included in the second video 402. In FIG. 8A, the left-eye images are indicated as L 1, L 2, L 3, . . . , and the right-eye images are indicated as R 1, Right 2, R 3, . . . .

(b) in FIG. 8A shows, at subsequent Step S708 in FIG. 7, the first video 401 and the second video 402 which the image adjustment unit 230 reads from the memory 232 and outputs.

More specifically, for example, at each time for outputting a right-eye image, the image adjustment unit 230 reads an immediately-prior left-eye image among the images included in the second video 402 and outputs the readout left-eye image. Therefore, as shown in (b) in FIG. 8A, each of the images L 1, L 2, L 3, . . . is outputted twice.

(c) in FIG. 8A shows, at subsequent Step S709 in FIG. 7, a video 405 which is generated by converting the second video 402 to a stereoscopic video having a uniform disparity by the 2D-3D conversion unit 234.

More specifically, for example, among the images included in the second video 402 shown in (b) in FIG. 8A, the 2D-3D conversion unit 234 translates each image corresponding to a corresponding time for outputting a right-eye image, to the right in the horizontal direction of the display screen 400. In other words, among the images included in the second video 402 in (b) in FIG. 8A, a target image corresponding to a time for outputting a right-eye image is replaced by an image (each of images indicated as R 1′, R 2′, and R 3′, . . . in (c) in FIG. 8A which are referred to as a “third video 403”) that is generated by translating the target image to the right in the horizontal direction of the display screen 400.

An amount of the translation is determined based on a position of the first plane 501a of the first video 401 which is calculated by the disparity detection unit, so that the viewer 500 perceives the second video 402 as deeper than the first plane 501a.

(d) of FIG. 8A shows, at subsequent Step S710 in FIG. 7, a synthesized video 406 synthesized by the image synthesis unit 233. More specifically, the image synthesis unit 233 synthesizes the images L 1, L 2, L 3, . . . which are included in the first video 401 with the left-eye images L 1, L 2, L 3, . . . which are included in the second video 402, respectively. In addition, the image synthesis unit 233 synthesizes the right-eye images R 1, R 2, and R 3, . . . which are included in the first video 401 with the images R 1′, R 2′, R 3′, . . . which are included in the third video 403, respectively. The resulting video 406 consisting of these synthesized images is outputted in synchronization with the above-described vertical synchronization signal and LR signal.

Next, the description is given for the image signal processing in the case where the second video 402 is a two-dimensional video.

FIG. 8B is a diagram schematically showing an example of the stereoscopic image processing according to Embodiment 1 in the case where the second video 402 is a two-dimensional image (No at S707 in FIG. 7).

(a) in FIG. 8B shows, at Step S707 in FIG. 7, the first video 401 and the second video 402 which are stored in the memory 232. More specifically, the memory 232 holds: left-eye images and right-eye images included in the first video 401; and images included in the second video 402. In FIG. 8B, the left-eye images are indicated as L 1, L 2, L 3, . . . , the right-eye images are indicated as R 1, R 2, R 3, . . . , and the two-dimensional images are indicated simply as numerals 1, 2, 3, 4, 5, 6, . . . .

(b) in FIG. 8B shows, at subsequent Step S708 in FIG. 7, the first video 401 and the second video 402 which the image adjustment unit 230 reads from the memory 232 and outputs.

Here, since the second video 402 is a two-dimensional video, the image adjustment unit 230 reads the first video 401 and the second video 402 and outputs the readout videos without performing the image processing (the 3D-2D conversion).

(c) in FIG. 8B shows, at subsequent Step S709 in FIG. 7, a video 407 which is generated by converting the second video 402 to a stereoscopic video having a uniform disparity by the 2D-3D conversion unit 234.

More specifically, for example, among the images included in the second video 402 in (b) in FIG. 8B, the 2D-3D conversion unit 234 translates each image corresponding to a time for outputting a right-eye image, to the right in the horizontal direction of the display screen 400 and outputs the resulting image. In other words, among the images included in the second video 402 in (b) in FIG. 8B, a target image corresponding to a time for outputting a right-eye image is replaced by an image (each of images indicated as 1′, 3′, 5′ . . . in (c) in FIG. 8B which are referred to as a “fourth video 404”) which is generated by translating the target image to the right in the horizontal direction of the display screen 400.

An amount of the translation is determined based on a position of the first plane of the first video 401 which is calculated by the maximum disparity detection unit 236, so that the viewer 500 perceives the second video 402 as deeper than the first plane of the first video 401.

(d) of FIG. 8A shows, at subsequent Step S710 in FIG. 7, a video 408 synthesized by the image synthesis unit 233. More specifically, the image synthesis unit 233 synthesizes the left-eye images L 1, L 2, L 3, . . . which are included in the first video 401 with the images 1, 3, 5, . . . which are included in the second video 402, respectively. In addition, the image synthesis unit 233 synthesizes the right-eye images R 1, R 2, R 3, . . . which are included in the first video 401 with the images 1′, 3′, 5′, . . . which are included in the fourth video, respectively. The resulting video 407 consisting of these synthesized images is outputted in synchronization with the above-described vertical synchronization signal and LR signal.

Thus, the stereoscopic image processing performed by the stereoscopic image processing device 20 according to Embodiment 1 has been described with reference to FIGS. 7, 8A, and 8B. Thereby, the multi-screen display of stereoscopic videos not causing the viewer 500 to feel uncomfortable is provided.

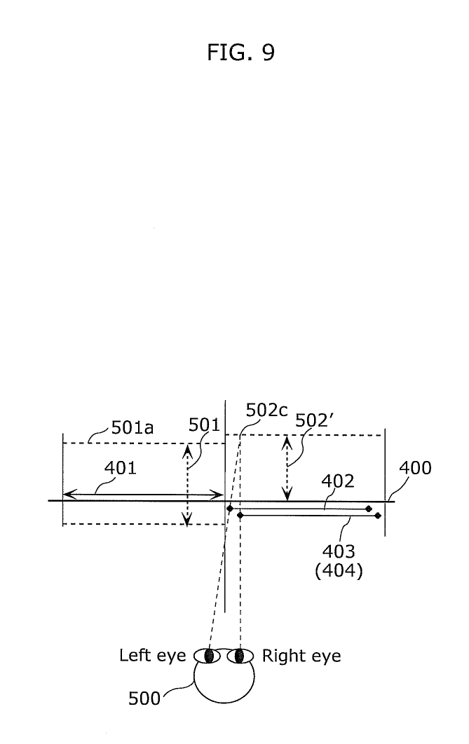

FIG. 9 is a diagram showing how the viewer 500 perceives videos on which the stereoscopic image processing according to Embodiment 1 has been performed. FIG. 9 is a top view of the display screen 400 and the viewer 500. In FIG. 9, although the first video 401 and the second video 402 are separately shown, in practice, the video 406 or the video 408 which is synthesized in the above-described manner is displayed on the display screen 400.

As shown in FIG. 9, the first video 401 has the maximum disparity range 501, and the plane passing through a position which the viewer 500 perceives the farthest in the first video 401 is the first plane 501a.

In contrast, regarding the second video 402, by the above-described stereoscopic image processing, the second video 402 is displayed as left-eye images and the third video 403 (or the fourth video 404) is displayed as right-eye images. In other words, the second video 402 is displayed as a stereoscopic video having a uniform disparity 502′. As a result, the viewer 500 perceives the second video 402 as a two-dimensional video displayed on a plane 502c. It should be noted that the stereoscopic video having the uniform disparity 502′ has a disparity range of 0.

It should be noted that the first plane 501a and the plane 502c may be the same plane. In other words, the situation where the second video is displayed deeper than the first video means that, more specifically, for example, the second video appears on the first plane or farther than the first plane.

As described above, as the results of the signal processing performed by the stereoscopic image processing device, the viewer 500 perceives the second video 402 as displayed as a two-dimensional video deeper than the screen so that the second video 402 does not prevent the viewer 500 from viewing the first video 401. Thereby, the multi-screen display of stereoscopic videos not causing the viewer 500 to feel uncomfortable is provided. For example, the viewer 500 can view, at the same time, a main video (first video 401) which the viewer 500 wishes to mainly view and a sub video (second video 402) which the viewer 500 wishes to sometimes view. In addition, the viewer 500 is not prevented by the sub video from viewing the main video.

Furthermore, although the first video 401 has a decreased size on the display screen 400, the first video 401 is displayed as a stereoscopic video having the same disparity as a disparity in the case where the first video 401 is displayed on the whole display screen 400. Therefore, the viewer 500 can view the first video 401 keeping the same features as those in the case where the first video 401 is displayed on the display screen 400.

Likewise, the second video 402 is perceived as a two-dimensional video appearing deeper than the screen, having the same features as those in the case where the second video 402 is displayed as a two-dimensional video on the display screen 400.

The processing shown in FIGS. 7, 8A, and 8B is performed, for example, in the following situation. While the first video 401 and the second video 402 which have been acquired by the acquisition unit 22 are displayed on the display screen 400 without the image processing, the viewer 500 selects one (the first video 401) of two the videos by using the input sending unit 10. More specifically, the input receiving unit 21 receives instructions from the input sending unit 10, and the CPU 26 performs the processing according to the instructions.

The above description is assumed in the situation where, for example, the viewer 500 prefers the first video 401 to the second video 402 to view.

Even if the viewer 500 does not expressly selects a video, the stereoscopic image processing device 20 may treat a specific video as a selected video (the first video 401). For example, if two videos are displayed as shown in FIG. 6A, it is possible to process a video on the left side of the display as the first video 401. Furthermore, for example, it is also possible that a larger one of the two videos on the display screen 400 is processed as the first video 401.

If the first video 401 is a two-dimensional video (No at Step S703 in FIG. 7), the first video 401 is converted by the image adjustment unit 230 to a stereoscopic video having a predetermined disparity range. Therefore, the maximum disparity detection unit 236 can be eliminated.

On the other hand, even if the first video 401 is a stereoscopic video (Yes at Step S703 in FIG. 7), it is possible that the 3D-2D conversion is performed for reading the first video 401 from the memory 232 as a two-dimensional video, and the first video 401 is further converted by the 2D-3D conversion unit 234 to a stereoscopic video. As a result, the first video 401 is converted to a stereoscopic video having a predetermined disparity range, so that the maximum disparity detection unit 236 can be eliminated.

Moreover, the second video 402 may be displayed on a plane which the viewer 500 perceives the farthest in a disparity range determined by a Biological Safety Guideline. The disparity range determined by the Biological Safety Guideline is defined by Japan Electronics and Information Technology Industries Association as a disparity range within which viewers can safely view videos.

When a video appears deeper than the display screen 400 as viewed from the viewer 500, a limit of the disparity range defined by the Biological Safety Guideline is defined as no more than 5 cm on the display screen 400 on which the stereoscopic video is displayed.

Therefore, the 2D-3D conversion unit 234 may convert the second video 402 to a video having a uniform disparity equivalent to 5 cm on the display screen 400 without using the maximum disparity detection unit 236 (5 cm on the display screen 400 is equivalent to, for example, 67 pixels on a 65-inch display screen).

### Embodiment 2

The following describes Embodiment 2 according to the present invention.

Unless otherwise noted, the same reference numerals in Embodiment 1 are assigned to the structural elements with the same functions and the same processing in Embodiment 2, so that they are not described again.

In Embodiment 1, an example where the second video 402 is converted to a stereoscopic video having a uniform disparity has been described. However, it is also possible to perform the image processing on the first video 401 not to cause the second video 402 to prevent the viewer from viewing the first video 401.

In Embodiment 2, the system configuration and the block diagrams are totally the same as FIGS. 1, 2, and 3.

The first video 401 outputted from the image adjustment unit 230 is provided to the 2D-3D conversion unit 234 that further converts the first video 401 to have a uniform disparity. The second video 402 is converted by the image adjustment unit 230 to a two-dimensional video in the same manner as described in Embodiment 1, and then outputted. The first video 401 which has been further converted to have the uniform disparity and the second video 402 which has been converted to a two-dimensional video are outputted by the image synthesis unit 233 as a synthesized video.

Furthermore, the processing according to Embodiment 2 differs from the processing according to Embodiment 1 in Step S709 in the flowchart of FIG. 7.

In Embodiment 2, instead of Step S709 in FIG. 7, the 2D-3D conversion unit 234 further converts the first video 401 to have a uniform disparity.

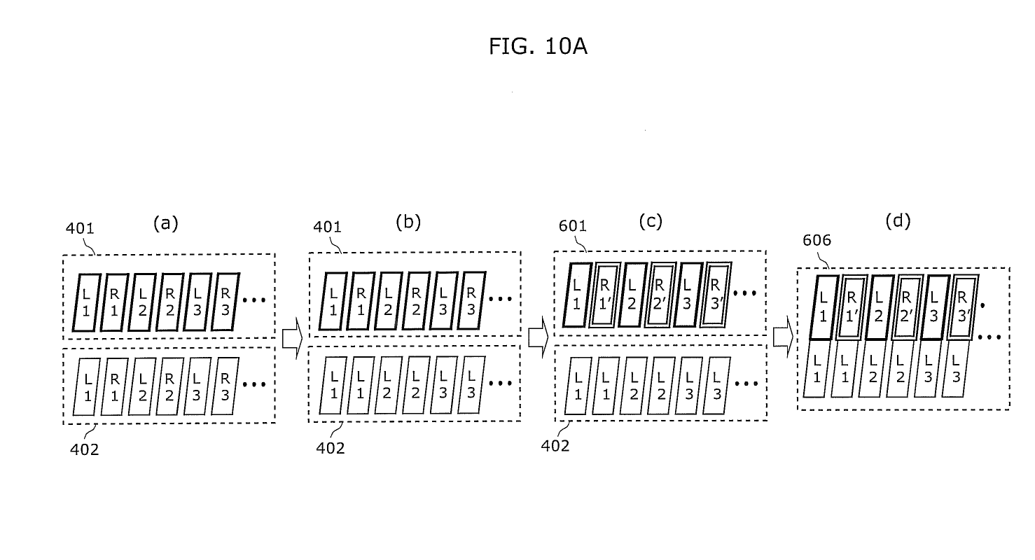

FIG. 10A is a diagram schematically showing an example of the stereoscopic image processing according to Embodiment 2 in the case where the second video 402 is a stereoscopic video.

(a), (b), and (d) in FIG. 10A are just the same as the figures in Embodiment 1, so that they are not described again.

In (c) in FIG. 10A, instead of Step S709 in FIG. 7, the 2D-3D conversion unit 234 further converts the first video 401 to have a uniform disparity.

More specifically, for example, the 2D-3D conversion unit 234 translates each right-eye image in the first video 401 in (b) in FIG. 10A, to the right in the horizontal direction of the display screen 400, and outputs the resulting image. In other words, among the images included in the first video 401 in (b) in FIG. 10A, a target image corresponding to a time for outputting a right-eye image is replaced by an image (each of images indicated as R 1′, R 2′, R 3′, . . . in (c) in FIG. 10A) that is generated by translating the target image to the right in the horizontal direction of the display screen 400.

An amount of the translation is determined based on a position of the first plane 501a of the first video 401 which is calculated by the disparity detection unit, so that the viewer 500 perceives the first plane 501a on the same plane as the display screen or ahead of the display screen. As a result, the first video 401 is outputted as a video 601 that is the first video 401 with the uniform disparity.

(d) in FIG. 10A shows, at the step subsequent to (c) in FIG. 10A, a video 606 synthesized by the image synthesis unit 233. More specifically, the image synthesis unit 233 synthesizes the images L 1, L 2, L 3, . . . which are included in the video 601 having the uniform disparity with the left-eye images L 1, L 2, L 3, . . . which are included in the second video 402, respectively. In addition, the image synthesis unit 233 synthesizes the right-eye images R 1, R 2, R 3, . . . which are included in the video 601 with the images R 1′, R 2′, R 3′, . . . which are included in the second video 402, respectively. The resulting video 606 consisting of these synthesized images is outputted in synchronization with the above-described vertical synchronization signal and LR signal.

FIG. 10B is a diagram schematically showing an example of the stereoscopic image processing according to Embodiment 2 in the case where the second video 402 is a two-dimensional video.

As shown in FIG. 10B, the processing in the case where the second video 402 is a two-dimensional video is totally the same as the processing in FIG. 10A.

Thus, the stereoscopic image processing performed by the stereoscopic image processing device 20 according to Embodiment 2 has been described with reference to FIGS. 10A and 10B. Thereby, the stereoscopic image processing according to Embodiment 2 can also provide the multi-screen display of stereoscopic videos not causing the viewer 500 to feel uncomfortable.

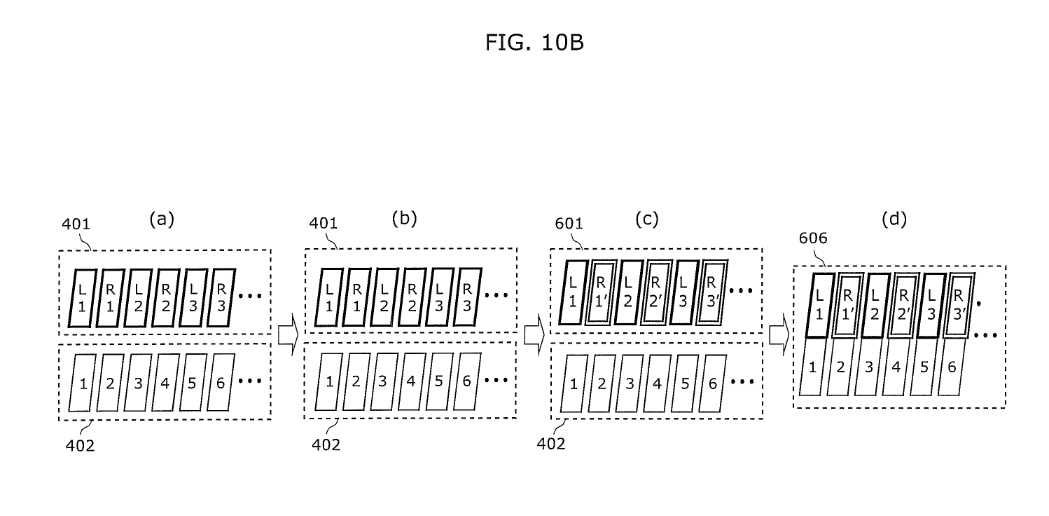

FIG. 11 is a diagram showing how the viewer 500 perceives videos on which the stereoscopic image processing according to Embodiment 2 has been performed. FIG. 11 is a top view of the display screen 400 and the viewer 500. In FIG. 11, although the first video 401 and the second video 402 are separately shown, in practice, the video 606 which is synthesized in the above-described manner is displayed on the display screen 400.

As shown in FIG. 11, as a result of further conversion on the first video 401 to have a uniform disparity, the first video 401 is displayed having the maximum disparity range 501, so that the first plane 501a appears ahead of the display screen. In other words, the first video 401 on the whole appears closer to the viewer than the case without the image processing, keeping the disparity of the whole video (a popout region and a depth region).

Therefore, the viewer 500 can view the first video 401 keeping the same features as those prior to the image processing.

In contrast, the second video 402 is displayed on the display screen as a two-dimensional video.

More specifically, the second video 402 is displayed as a video having the same features as those in the case where the second video 402 is displayed as a two-dimensional video on the display screen 400.

It should be noted that, if the first video 401 is a two-dimensional video, the image adjustment unit 230 converts the first video 401 to a stereoscopic video having a predetermined disparity range. It is also possible that, in the conversion, the first video 401 is converted to a stereoscopic video so that the viewer 500 perceives the first plane 501a on the same plane as the display screen or ahead of the display screen. In this case, the maximum disparity detection unit 236 can be eliminated.

Furthermore, if the first video 401 is converted to have a uniform disparity, there is a possibility that the uniform disparity exceeds the limit of the disparity range in a popout direction defined in the above-described Biological Safety Guideline. More specifically, there is a possibility that the second plane 501b in FIG. 11 exceeds the limit of the disparity range.

In such a case, it is possible to reduce a disparity on the whole (reduce the maximum disparity range 501) by the image adjustment unit 230. Furthermore, if the processing on the first video 401 according to a maximum disparity detected by the maximum disparity detection unit 236 exceeds a safe disparity range, the processing may be switched to the processing according to Embodiment 1.

### Embodiment 3

The following describes Embodiment 3 according to the present invention.

Unless otherwise noted, the same reference numerals in Embodiment 1 are assigned to the structural elements with the same functions and the same processing in Embodiment 3, so that they are not described again.

The stereoscopic image processing device 20 according to Embodiments 1 and 2 performs the image processing so that the second video 402 appears farther than the first plane 501a of the first video 401.

In contrast, in Embodiment 3, the description is given for the image processing device that displays the first video 401 and the second video 402 as a stereoscopic video having the same maximum disparity range in order to reduce the load on the viewer 500.

In Embodiment 3, the system configuration and the block diagrams are totally the same as FIGS. 1, 2, and 3.

The stereoscopic image processing device 20 according to Embodiment 3 displays the first video 401 and the second video 402 at the same time on the display screen 400 as a stereoscopic video. The stereoscopic image processing device 20 includes: the acquisition unit 22 that acquires the first video 401 and the second video 402; the 3D-2D conversion unit (the image adjustment unit 230) that converts the first video 401 and the second video 402 to two-dimensional videos when the first video 401 and the second video 402 are stereoscopic videos; the image synthesis unit 233 that synthesizes (a) the first video 401 that is a two-dimensional image acquired by the acquisition unit 22 or converted by the image adjustment unit 230 and (b) the second video 402 that is a two-dimensional video that is acquired by the acquisition unit 22 or converted by the image adjustment unit 230 so as to generate a two-dimensional video; and the 2D-3D conversion unit 234 that converts the two-dimensional video synthesized by the image synthesis unit 233 to a stereoscopic video.

The following describes the processing performed by the stereoscopic image processing device 20 according to Embodiment 3.

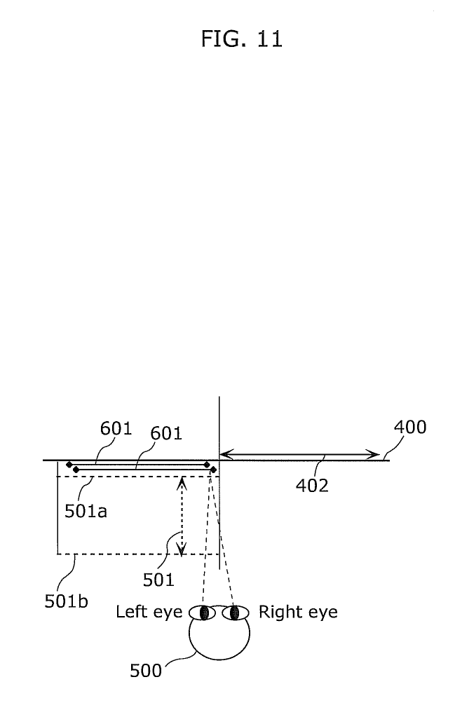

FIG. 12 is a flowchart of the stereoscopic image processing according to Embodiment 3.

First, the acquisition unit 22 acquires a first video and a second video (S1201).

Next, the image adjustment unit 230 scales the first video 401 (S1202).

If the first video 401 is a stereoscopic video (Yes at S1203), the image adjustment unit 230 performs 3D-2D conversion on the scaled first video 401 (S1204). More specifically, as described with reference to FIG. 4, the image adjustment unit 230 reads either right-eye images or left-eye images of the first video 401 from the memory 232, and provides the readout images to the 2D-3D conversion unit 234.

On the other hand, if the first video 401 is not a stereoscopic video (No at S1203), the image adjustment unit 230 reads the first video 401 from the memory 232 as a two-dimensional video without performing the image processing, and outputs the readout first video 401 to the image synthesis unit 233.

Next, the image adjustment unit 230 scales the second video 402 (S1205).

If the first video 401 is a stereoscopic video (Yes at S1206), the image adjustment unit 230 performs 3D-2D conversion on the scaled first video 401 (S1207). More specifically, as described with reference to FIG. 4, the image adjustment unit 230 reads either right-eye images or left-eye images of the second video 402 from the memory 232, and provides the readout images to the 2D-3D conversion unit 234.

On the other hand, if the second video 402 is not a stereoscopic video (No at S1206), the image adjustment unit 230 reads the second video 402 from the memory 232 as a two-dimensional video without performing the image processing, and outputs the readout second video 402 to the image synthesis unit 233.

Subsequently, the image synthesis unit 233 synthesizes the first video 401 and the second video 402 which are outputted as two-dimensional videos from the image adjustment unit 230, into a two-dimensional video (S1208), and provides the resulting two-dimensional video to the 2D-3D conversion unit.

Finally, the 2D-3D conversion unit 234 converts the two-dimensional video synthesized by the image synthesis unit 233 into a stereoscopic video, and provides the stereoscopic video to the display device 24 (S1209). Thereby, the first video 401 and the second video 402 have the same maximum disparity range. As a result, multi-screen display not causing the viewer to feel uncomfortable is provided.

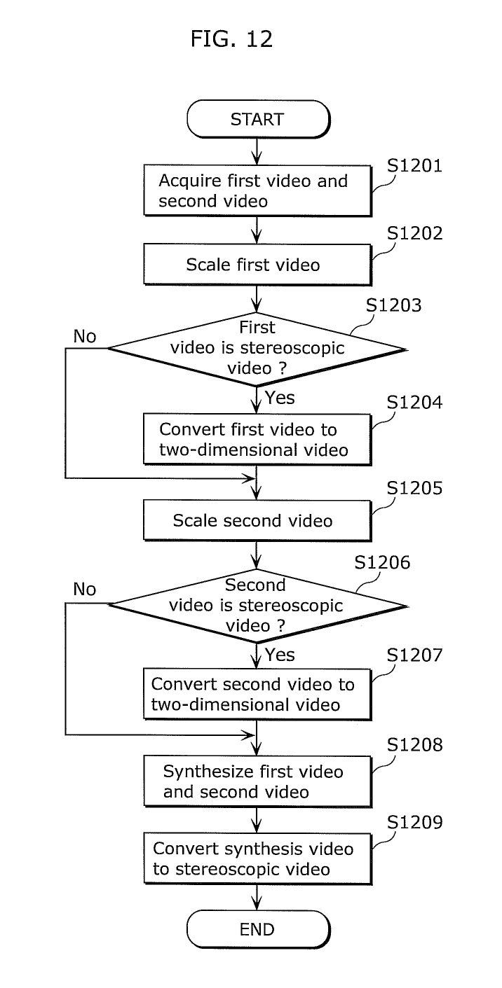

FIG. 13 is a diagram showing how the viewer 500 perceives videos on which the stereoscopic image processing according to Embodiment 3 has been performed. FIG. 13 is a top view of the display screen 400 and the viewer 500. In FIG. 13, although the first video 401 and the second video 402 are separately shown, in practice, a video which is synthesized in the above-described manner is displayed on the display screen 400.

As shown in FIG. 13, each of the first video 401 and the second video 402 is displayed as a stereoscopic video having a maximum disparity range 501′.

It should be noted that the processing shown in FIG. 12 is performed, for example, when the viewer 500 instructs multi-screen display by using the input sending unit 10. More specifically, the input receiving unit 21 receives instructions from the input sending unit 10, and the CPU 26 performs the processing according to the instructions.

It should be noted that the image processing according to Embodiment 1 and the image processing according to Embodiment 3 may be combined together.

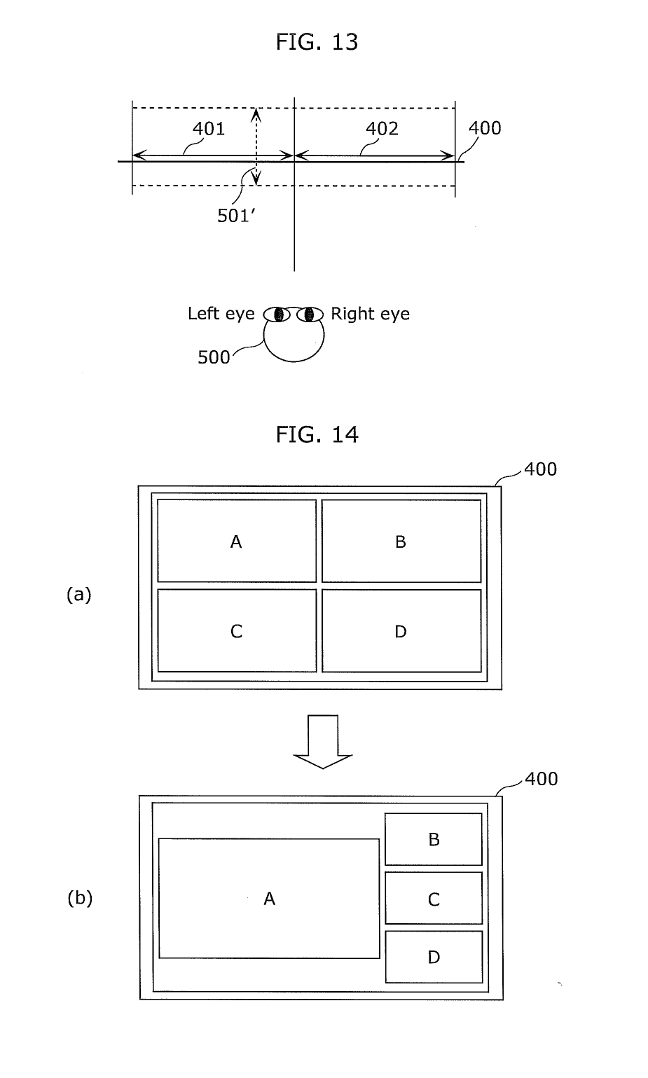

FIG. 14 is a diagram showing stereoscopic image processing according to an example of the present invention.

If the viewer 500 instructs multi-screen display by using the input sending unit 10, as shown in (a) in FIG. 14, the stereoscopic image processing device 20 displays a plurality of videos on the display screen 400 of the display device 24. In (a) in FIG. 14, as a result of the image processing according to Embodiment 3, four videos A to D are displayed as respective stereoscopic videos. In other words, the four videos A to D have the same maximum disparity range (a maximum disparity in a depth direction and a maximum disparity in a popout direction).

In the situation shown in (a) in FIG. 14, if the viewer 500 using the input sending unit 10 designates the video A as a target video which the viewer 500 intends to focus on, as shown in (b) in FIG. 14, a size of the video A on the display screen 400 is increased by scaling processing of the image adjustment unit 230, and a displayed position of the video A is adjusted by a position adjustment function of the image adjustment unit 230. Likewise, for each of the videos B to D, a size is decreased by scaling processing of the image adjustment unit 230, and a displayed position is adjusted by the position adjustment function of the image adjustment unit 230.

In the situation shown in (b) in FIG. 14, the stereoscopic image processing device 20 performs image processing according to Embodiment 1 (or Embodiment 2). In other words, the video A designated by the viewer 500 is displayed as a stereoscopic video, while the videos B to D are displayed as respective stereoscopic videos having a uniform disparity. The videos B to D appear as respective two-dimensional videos on a plane farther than the first plane of the video A perceived by the viewer 500. Therefore, the viewer 500 can view the videos A to D at the same time, and the videos B to D do not prevent the viewer 500 from viewing the video A.

It should be noted that the viewer 500 may select, as target videos which the viewer 500 intends to focus on, a plurality of videos by using the input sending unit 10. In this case, each of the selected videos is processed as the first video 401 according to Embodiment 1, while each of the other videos is processed as the second video 402 according to Embodiment 1.

### VARIATIONS

It should be noted that the present invention may be modified in the following ways.

(1) Each of the above devices according to the embodiments may be implemented to a computer system including a microprocessor, a Read Only Memory (ROM), a Random Access Memory (RAM), a hard disk unit, a display unit, a keyboard, a mouse, and the like. The RAM or the hard disk unit holds a computer program. The microprocessor operates according to the computer program, thereby causing each of the devices to perform its functions. Here, the computer program consists of combinations of instruction codes for issuing instructions to the computer to execute predetermined functions.

(2) It should be noted that a part or all of the structural elements included in each of the devices according to the above embodiments may be implemented into a single Large Scale Integration (LSI). The system LSI is a super multi-function LSI that is a single chip into which a plurality of structural elements are integrated. More specifically, the system LSI is a computer system including a microprocessor, a ROM, a RAM, and the like. The RAM holds a computer program. The microprocessor loads the computer program from the ROM to the RAM and operates calculation and the like according to the loaded computer program, so as to cause the system LSI to perform its functions.

It should also be noted that a part or all of the structural elements included in each of the devices may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to perform its functions. The IC card or the module may have tamper resistance.

(4) It should also be noted that the present invention may be the above-described method. The present invention may be a computer program causing a computer to execute the method, or digital signals indicating the computer program.

It should also be noted that the present invention may be a computer-readable recording medium on which the computer program or the digital signals are recorded. Examples of the computer-readable recording medium are a flexible disk, a hard disk, a Compact Disc (CD)-ROM, a magnetooptic disk (MO), a Digital Versatile Disc (DVD), a DVD-ROM, a DVD-RAM, a BD (Blue-ray® Disc), and a semiconductor memory. The present invention may be digital signals recorded on the recording medium.

It should also be noted in the present invention that the computer program or the digital signals may be transmitted via an electric communication line, a wired or wireless communication line, a network represented by the Internet, data broadcasting, and the like.

It should also be noted that the present invention may be a computer system including a microprocessor operating according to the computer program and a memory storing the computer program.

It should also be noted that the program or the digital signals may be recorded onto the recording medium to be transferred, or may be transmitted via a network or the like, so that the program or the digital signals can be executed by a different independent computer system.

(5) It should also be noted that the above-described embodiments and variations may be combined.

### CONCLUSION

Thus, the embodiments and the variations of the stereoscopic image processing device according to the aspects of the present invention have been described.

The stereoscopic image processing device 20 according to Embodiment 1 displays the second video 402 as a two-dimensional video appearing deeper than the screen not to prevent the viewer from viewing the first video 401.

The stereoscopic image processing device 20 according to Embodiment 2 displays the second video 402 as a two-dimensional video on the display screen, and displays the first video 401 so that the first plane 501a of the first video 401 appears closer to the viewer 500 than the display screen is.

Furthermore, the stereoscopic image processing device 20 according to Embodiment 3 converts the first video 401 and the second video 402 to respective stereoscopic videos having the same maximum disparity range, and displays the stereoscopic videos.

Therefore, it is possible to provide stereoscopic image multi-screen display which does not cause a viewer to feel uncomfortable or loads. As a result, it is possible to provide safe stereoscopic image multi-screen display having a low risk of damaging health of a viewer viewing videos.

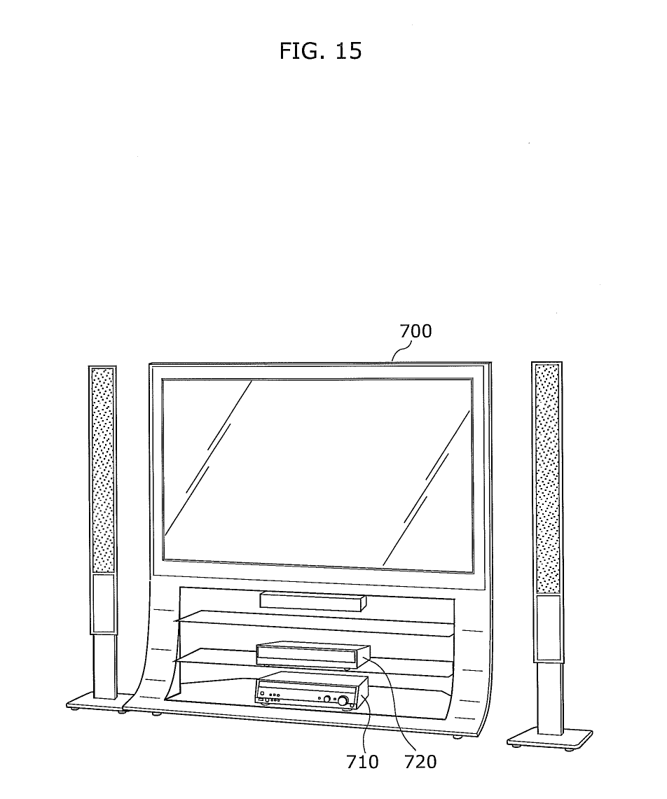

It should be note that the stereoscopic image processing device 20 according each of the embodiments may be implemented, for example, to a television set 700 shown in FIG. 15. Here, the detailed structure of the display device 24 is not specifically limited. For example, the display device 24 may be a liquid crystal display device, a plasma display device, an organic light emitting display device, or the like which can offer stereoscopic display. In this case, the acquisition unit 22 acquires videos from television broadcast, a Blu-Ray player 710 shown in FIG. 15, or a set-top box 720 shown in FIG. 15.

It should also be noted that the stereoscopic image processing device 20 may be implemented to the Blu-Ray player 710. In this case, the acquisition unit 22 acquires a video from an inserted Blu-Ray disk. It should be noted that the source from which videos are acquired is not limited to Blu-Ray disks, but videos may be acquired from various recording mediums such as DVDs, Hard Disc Drives (HDDs), and the like.

Furthermore, the stereoscopic image processing device 20 may be implemented to the set-top box 720. In this case, the acquisition unit 22 acquires videos from cable television broadcast or the like.

It should further be noted that the present invention may be, of course, implemented as a stereoscopic image processing method.

It should further be noted that the present invention is not limited to any of these embodiments and their variations. Those skilled in the art will be readily appreciate that various modifications and combinations of the structural elements and functions in the embodiments and variations are possible without materially departing from the novel teachings and advantages of the present invention. Accordingly, all such modifications and combinations are intended to be included within the scope of the present invention.

### INDUSTRIAL APPLICABILITY

The stereoscopic image processing device according to the present invention is useful as a television receiving device.

### REFERENCE SIGNS LIST

10 input sending unit
20 stereoscopic image processing device
21 input receiving unit
22 acquisition unit
23 processing unit
24 display device
25 eyeglass transmission unit
26 CPU
30 stereoscopic image viewing eyeglasses
232 memory
233 image synthesis unit
234 2D-3D conversion unit
235 CPU I/F
236 maximum disparity detection unit
300, 400 display screen
301a, 301b, 302a, 302b image
303a, 303b distance
310, 500 viewer
401 first video
402 second video
403 third video
404 fourth video
405, 406, 407, 408 video
501, 501′, 502 maximum disparity range
501a, 502a first plane
501b, 502b second plane
502′ uniform disparity
502c plane
601, 606 video
700 television set
710 Blu-Ray player
720 set-top box

1. A stereoscopic image processing device which displays a first image and a second image on a same display screen at a same time, the first image being a stereoscopic image, the second image being one of a stereoscopic image and a two-dimensional image, the stereoscopic image processing device comprising:
an acquisition unit configured to acquire the first image and the second image; and
a processing unit configured to perform image processing on one of the first image and the second image so that, when a viewer views the first image, the second image appears to be deeper than the first image.

2. The stereoscopic image processing device according to claim 1,
wherein the processing unit is configured to process one of the first image and the second image so that the second image appears to be a two-dimensional image displayed deeper than the first image.

3. The stereoscopic image processing device according to claim 2,
wherein the processing unit is configured to,
in a case where a plane which passes through a position appearing farthest from the viewer in the first image when the viewer views the first image and is parallel to the display screen is a first plane,
perform the image processing on one of the first image and the second image, so that the viewer perceives the second image as a two-dimensional image displayed on the first plane or that the viewer perceives the second image as a two-dimensional image displayed farther than the first plane.

4. The stereoscopic image processing device according to claim 3,
wherein the processing unit is configured to convert the second image to a stereoscopic image having a uniform disparity, so that the viewer perceives the second image as a two-dimensional image displayed on a same plane as the first plane or that the viewer perceives the second image as a two-dimensional image displayed farther than the first plane.

5. The stereoscopic image processing device according to claim 4,
wherein the second image is a stereoscopic image, and
the processing unit is configured to:
select, as a selected image, one of a left-eye image and a right-eye image which are included in the second image;
generate a third image by translating the selected image in a horizontal direction of the display screen; and
convert the second image to a stereoscopic image in which one of the selected image and the third image is a left-eye image and an other one of the selected image and the third image is a right-eye image.

6. The stereoscopic image processing device according to claim 4,
wherein the second image is a two-dimensional image, and
the processing unit is configured to:
generate a fourth image by translating the second image in a horizontal direction of the display screen; and
convert the second image to a stereoscopic image in which one of the second image and the fourth image is a left-eye image and an other one of the second image and the fourth image is a right-eye image.

7. The stereoscopic image processing device according to claim 3,
wherein the processing unit is configured to
display the second image as a two-dimensional image on the display screen, and
process the first image to have a uniform disparity so that the viewer perceives the first plane as a same plane as a plane of the display screen or as a plane closer to the viewer than the display screen is.

8. The stereoscopic image processing device according to claim 7,
wherein the second image is a stereoscopic image, and
the processing unit is configured to
display, on the display screen, only one of a left-eye image and a right-eye image which are included in the second image, and
convert only one of a left-eye image and a right-eye image which are included in the first image into an image by translating the one of the left-eye image and the right-eye image in a horizontal direction of the display screen.

9. The stereoscopic image processing device according to claim 7,
wherein the second image is a two-dimensional image, and
the processing unit is configured to
convert one of a left-eye image and a right-eye image which are included in the first image into an image by translating the one of the left-eye image and the right-eye image in a horizontal direction of the display screen.

10. The stereoscopic image processing device according to claim 1, further comprising
a scaler that changes a size of the first image and a size of the second image on the display screen.

11. The stereoscopic image processing device according to claim 1, further comprising
an input receiving unit configured to receive an input of the viewer to select, from among images displayed on the display screen, an image which the viewer intends to focus on,
wherein the first image is an image selected by the viewer.

12. The stereoscopic image processing device according to claim 3,
wherein the first plane is a plane appearing in parallel to the display screen.

13. A stereoscopic image processing method of displaying a first image and a second image on a same display screen at a same time, the first image being a stereoscopic image and the second image being one of a stereoscopic image and a two-dimensional image, the stereoscopic image processing method comprising:
acquiring the first image and the second image; and
performing image processing on one of the first image and the second image so that, when a viewer views the first image, the second image appears to be deeper than the first image.
